(19) United States
(12) Patent Application Publication
(10) Pub. No.: US 2016/0104189 A1
(43) Pub. Date: Apr. 14, 2016

(54) IN-AISLE COMPETITIVE OFFER PUSH SYSTEM AND METHOD

(71) Applicant: MOBISAVE LLC, New York, NY (US)

(72) Inventor: Steven Marcus, New Rochelle, NY (US)

(21) Appl. No.: 14/974,900

(22) Filed: Dec. 18, 2015

Related U.S. Application Data
(63) Continuation-in-part of application No. 12/950,103, filed on Nov. 19, 2010.
(60) Provisional application No. 61/263,211, filed on Nov. 20, 2009.
(60) Provisional application No. 61/264,549, filed on Nov. 25, 2009.
(60) Provisional application No. 61/292,940, filed on Jan. 7, 2010.
(60) Provisional application No. 61/380,453, filed on Sep. 7, 2010.

(51) Int. Cl. G06Q 30/02; G06Q 30/06

(52) U.S. Cl. CPC G06Q 30/0234; G06Q 30/0255; G06Q 30/0629

(57) ABSTRACT

A method includes receiving an indication that a user is requesting a price comparison with respect to a product available for sale in a retail store aisle. The indication may be received at a time when the user is present in the aisle. The method further includes determining a competitive item that shares a product characteristic with the product available for sale in the aisle. In addition, the method includes transmitting an offer to the user to induce the user to purchase the competitive item.

### CROSS-REFERENCE TO RELATED APPLICATIONS

This application is a continuation-in-part of U.S. patent application Ser. No. 12/950,103, filed Nov. 19, 2010 entitled “SYSTEM AND METHOD OF ELECTRONICALLY VERIFYING REQUIRED PROOF-OF-PERFORMANCE TO SECURE PROMOTIONAL REWARDS” (now pending), which claimed benefits to the following provisional applications: U.S. Patent Application No. 61/263,211, filed on Nov. 20, 2009, (expired); U.S. Patent Application No. 61/264,549, filed Nov. 25, 2009 (expired); U.S. Patent Application No. 61/292,940, filed Jan. 7, 2010 (expired); and U.S. Patent Application No. 61/380,453, filed Sep. 7, 2010 (expired). The entire contents of those applications are incorporated herein by reference in their entirety for all purposes.

### BACKGROUND

### Field

This invention relates to electronically generating promotional offers targeted to individuals as they are engaged in shopping.

### SUMMARY

In an aspect of the invention, a proof-of-performance verification system may include a receipt processing facility that receives a receipt image, wherein the receipt processing facility optionally enhances the receipt, converts the receipt image to text, and matches the text to a product or service description in accordance with a terminology database, a proof processor that electronically matches a user-selected reward offer against the product or service description to facilitate offer redemption, and at least one of a payment facility that distributes the offer redemption funds and a rewards facility that communicates incentive rewards to a central location. The receipt image may be captured by an imaging facility of a handheld device, wherein the handheld device may be a mobile phone camera or web-enabled digital camera.

The receipt image may be captured by at least one of a webcam, flatbed scanner, a machine designed to capture and transmit images, and an in-store device that allows users to scan and transmit a receipt image. The proof processor may capture and store all information contained on the receipt image. The system may further include a graphical user interface that may allow a user to enter their identification information and/or select at least one offer. The system may further include a rewards offer facility that presents offers that can be redeemed with one or more receipt images as proof-of-performance. The system may further include a reporting facility that provides real-time tracking of offers and redemptions. The system may further include a dashboard that allows offer sponsors to manage and track offers and redemptions.

In an aspect of the invention, a method may include presenting at least one offer to a user for offer selection prior to a purchase of a corresponding product, wherein at least one selected offer can be redeemed by the user with a proof of purchase receipt for the corresponding product, receiving a proof of purchase receipt from a user, wherein the receipt is at least one of a receipt image and a digital receipt, in the case where the receipt is a receipt image, processing the receipt image by converting the receipt image to text using optical character recognition, matching at least one of the text of the receipt and a product code indicated by the receipt with a product or service description in a terminology database to determine at least one product indicated by the receipt, and matching the at least one product to the at least one selected offer, wherein a successful match of a selected offer to a purchased product as indicated by the proof of purchase receipt results in a redemption of the selected offer.

The method may further include enhancing the receipt by at least one of removing creases and modifying contrast. The product code may be one or more of a UPC code, text, or an SKU. Upon a successful product and offer match, a notification may be sent to the user. Upon a successful product and offer match, the redemption fund may be automatically transferred to the user.

In an embodiment, a computer program product may be embodied in a computer readable medium that, when executing on one or more computers, performs the steps of displaying, via a graphical user interface, an inventory list of product offers redeemable by users upon presentation of a proof of purchase receipt, receiving an input, via the graphical user interface, from a user, the input specifying a desired product offer from the inventory list of product offers to be redeemed after purchase of a corresponding product, receiving an input, via the graphical user interface, from a user, the input comprising the proof of purchase receipt from the user, wherein the receipt is at least one of a receipt image and a digital receipt, displaying, via the graphical user interface, an indication of a successful match of the desired product offer with a proof of purchase of a corresponding product, and displaying, via the graphical user interface, an indication of a redemption of the product offer, wherein the indication comprises an indication of a payment.

In an aspect of the invention, a method of aggregating consumers for a group purchase may include negotiating a cash back offer from a manufacturer, wherein the offer is contingent on a threshold number of users accepting the offer to purchase the product offered by the manufacturer, wherein the manufacturer's product is purchased from any retailer, providing each user an offer to participate in a group discount, wherein each member of the group purchases the opportunity to receive the offer upon verifying that a purchase of the manufacturer's product has been made, receiving proof of purchase verification from the user in the form of a digital image of a receipt or a digital receipt and, optionally, an indication of a registration card, and transmitting payment to the user who purchased the opportunity to receive the offer and subsequently verified that they purchased the product. Verification may include processing a digital image of the receipt for the manufacturer's product to extract proof-of-performance information, and electronically matching the discount offer against the proof-of-performance information.

In an aspect of the invention, a secure digital receipt system may include a receipts server in communication with a point-of-sale that prepares a secure digital receipt comprising an unalterable digital mark, associating the secure digital receipt with a user identification, and a communications facility that delivers the secure digital receipt to a user. The unalterable digital mark may prevent at least one of alteration, counterfeiting or duplication of the secure digital receipt. The unalterable digital mark is at least one of a bar code, QR code, or image. The unalterable digital mark may encode information including user ID, encryption device or image, encoded text, and a date. The user identification may include at least one of a unique sender ID, an email address and a mobile phone number. Another form of ID including at least one of a fingerprint, eye scan, facial recognition and password may be required to verify the identity of the user possessing the secure digital receipt.

In an aspect of the invention, a voice recognition system may include a voice recognition facility that recognizes a spoken word as a shopping list item, a user interface of the voice recognition facility that enables a user to create and edit a shopping list, wherein the shopping list is generated using the recognized shopping list items and, optionally, manually input shopping list items, and a rewards offer facility that comprises coupons, rebates, or other incentives related to the shopping list items, wherein when the shopping list item is recognized, the shopping list item is searched in a database of coupons or rebates or other purchase incentives for a match to communicate to a user. The voice recognition system may reside on an electronic device. The voice recognition system may reside on a server. The voice recognition system may further include a communications facility that transmits the shopping list to a shopping service that will pick and pack the shopping list items.

In an aspect of the invention, a voice recognition system may include a voice recognition facility that recognizes a spoken word as a shopping list item, a user interface of the voice recognition facility that enables a user to create and edit a shopping list, wherein the shopping list is generated using the recognized shopping list items and, optionally, manually input shopping list items, and a rewards offer facility that stores coupons, rebates, or other incentives related to the shopping list items, wherein when the shopping list item is recognized, the shopping list item is searched in a database of advertisements for a match to communicate to a user. The voice recognition system resides on an electronic device or a server. The voice recognition system may further include a communications facility that transmits the shopping list to a shopping service that will pick and pack the shopping list items.

In an aspect of the invention, a user who is at a retail store shopping may use his/her mobile device to request price comparison information as to possibly more advantageous sources of a product than the retail store. In addition to receiving price comparison information, the user may receive, via his/her mobile, a cash back offer on a competitive product that is comparable to the product that was the subject of the price comparison request. The terms of the cash back offer, such as the amount of the reward, may be determined based at least in part on one or more characteristics of the user that indicate his/her potential value as a customer for the manufacturer of the competitive product.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts a block diagram of a proof-of-performance verification system.

FIG. 2 depicts a secure digital receipt system.

FIG. 3 depicts a voice recognition system.

FIG. 4 depicts a series of images depicting a method of using the proof-of-performance verification system.

FIGS. 5A, 5B and 5C depict a logical flow for a method of using the proof-of-performance verification system.

FIG. 6 depicts a screenshot of a manufacturer dashboard.

FIG. 7 schematically depicts a shopper who is a participant in a competitive promotional offer system.

FIG. 8 depicts a competitive promotional offer system.

FIG. 9 depicts a computer that may be part of the competitive promotional offer system.

FIG. 10 depicts a mobile device that may be used in connection with the competitive promotional offer system.

FIGS. 11 and 12 depict logical flows for a method of using the competitive promotional offer system.

FIG. 13 depicts an example display of a competitive promotional offer on a mobile device.

### DETAILED DESCRIPTION

The invention allows consumers to secure promotional rewards, such as rebates for purchases or any other desired action, by electronically submitting proof-of-performance, such as proof-of-purchase or proof-of-visit, to the reward sponsor or reward processor in a proof-of-performance verification system. Such actions may occur either in physical retail outlets, at an in-store kiosk or scanning system, on the Internet, by using a webcam attached to a computer, on a communication device 108 such as a mobile phone or web-enabled digital camera, via postal mail or in any manner as desired and acceptable to the reward sponsor. Such proof may be in any electronic form including but not limited to scanned or photocopied receipts, video copied rewards, paperless receipts in the form of emails or text messages, downloaded receipts or performance data from a database of transactions, scanned itemized receipts collected by shoppers on a handheld device or other device, or direct transmission from any source that can provide and prove actual performance behavior.

A competitive promotional offer system may utilize functionality of the proof-of-performance verification system. The competitive promotional offer system may generate tailored offers to induce shoppers to consider purchasing products that are competitive with products that the shoppers have requested price comparisons for from the retail store aisle. The terms of the competitive offers may reflect information about the shoppers that is indicative of their potential value as customers for the manufacturers of the competitive products. Thus the in-aisle competitive offers may be dynamic in their terms as well as targeted to the users currently engaged in seeking the category of product that is the subject of the offer.

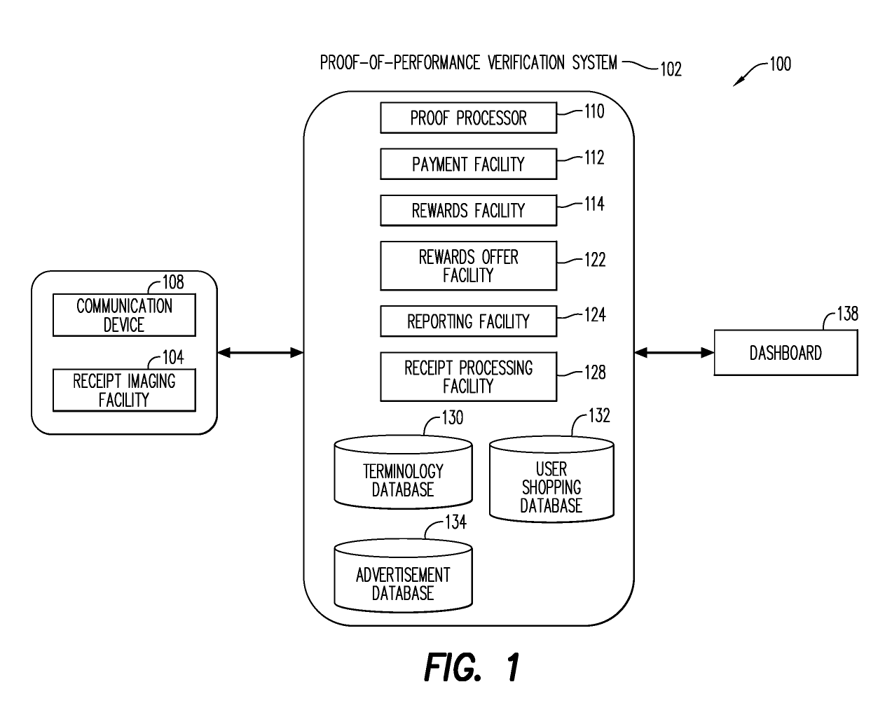

The communication device 108 (FIG. 1) may include a physical user interface that allows a user to enter their identification information and display offers and rebates. The user may provide personal identification via keyboard, touch screen, dipping a card, voice recognition, or any other method such as having a sent image tagged with their email address or mobile phone number.

In an embodiment, the system may enable retailer-agnostic rebates and offers—the offer or rebate may be made by the manufacturer of the item and the system may enable redemption of the offer or rebate regardless of where the item may be purchased. Thus, the user is free to purchase the item from any retailer, website, home shopping network, or the like, enabling them to get the best retail price, while still being eligible for additional savings with the manufacturer's rebate/offer that may be redeemed using the system of the invention. The system may include a rewards offer facility 122 that offers many rebates that can be submitted and approved with one or more receipts as proof-of-performance rather than individual proof-of-performance for each offer.

In certain embodiments, a registration card may also be required by the system in order for users to redeem receipts, such as by providing personal identification information. The registration card may enable third parties associated with the system, such as manufacturers, distributors and the like, to acquire customers using the information provided with the registration card.

In an embodiment, a user may learn about promotional offers through any medium including newspaper ads, email/SMS/MMS or “in-app” to their personal computer or their mobile phone, in-store through any advertising device, through a social networking website, through the proof-of-performance verification system, on a home shopping network television station, and the like.

In an embodiment, the user may interact with an application embodying the proof-of-performance verification system to review, select, and redeem offers. The system may be available for such interaction on a smartphone, mobile phone, web-enabled device, desktop computer, laptop computer, tablet computer, kiosk, web-enabled camera, and the like. Offers may be searched by category, product, offer amount, offer details, and the like. In an embodiment, the user may pre-select the offers they want to receive or redeem prior to purchasing the qualifying product. The user may print a list of the offers or download or send such offers to their mobile devices such as smart phones or other web enabled devices. In an embodiment, the system may present offers to individual members based on prior behavior or other distinguishing factor.

The user may then shop, either in a store or via an online shopping website, using the printed list or electronically viewing the selected offers, check out or otherwise pay for items, and retain the paper receipt and/or obtain an electronic receipt. In an embodiment, pre-selection of offers may be required in order to obtain an incentive for actually following through and making the purchase. In some embodiments, offers may be redeemed for items where the offer was not pre-selected but identified as a match anyway by the proof processor 110. Once the purchases have been completed, the user then is able to redeem the offers they pre-selected. The paper or digital receipt serves as the proof-of-performance for offer redemption. The system 102 accepts the receipts for processing in order to determine if an item for which an offer was pre-selected was indeed purchased. Multiple offers may be redeemed using a single receipt.

The proof-of-performance verification system 102 may include inputs from a receipt imaging facility 104, wherein the imaging facility 104 includes facilities for image and/or video capture, and optionally, enhancement and conversion of receipts to proof-of-performance. The imaging facility 104 may be connected to or integral with a communication device 108 that connects to a network, wherein the communication device 108 enables communication between the user and the system 102. The imaging facility 104 may be a handheld device, such as a mobile phone camera or web-enabled digital camera. The imaging facility 104 may be at least one of a webcam, flatbed scanner or a machine designed to capture and transmit images. The imaging facility 104 may be an in-store device that allows users to scan and transmit proof-of-purchase. The communication device 108 may be a kiosk, cell phone, smart phone, PDA, computer, tablet computer, and the like.

For example, the user may use a handheld device, such as a communication device 108, to photocopy or scan the receipt or they may visit a location in-store/nearby/in their office or home where a machine resides that can capture the required receipt image or electronic data. In one embodiment, the scan of the receipt may be in the form of series of photos which may be electronically joined together or a video of the receipt. In an embodiment, the imaging facility 104 may include automated features that facilitate capturing an image of the receipt. For example, in order to capture a series of photos to join into a single image of a long receipt, an accelerometer embedded in the communication device 108 may indicate that the user is holding the device 108 level and assist in steadying the image. When a first image is taken, the length of the portion of the receipt is determined. When the user goes to take the second image of the next portion of the long receipt, as the camera is moved down the receipt into position, the camera automatically senses where the last image left off by the length along the receipt traveled by the communication device 108, which may be sensed by an embedded accelerometer or other sensor that makes measurements such as length. In an embodiment, the device may indicate that the user should stop moving the camera. In other embodiments, the camera may automatically snap an image when it reaches an unimaged portion of the receipt. In an embodiment, a graphical user interface 102 may include a level bubble to graphically indicate when level has been reached.

In an embodiment, the proof processor 110 may capture and store all information contained on the proof-of-performance, including user information.

The receipts transmitted to the proof-of-performance verification system 102 may be sent to a proof processor 110 that electronically matches a reward offer against a proof-of-performance redemption. The proof processor 110 may include image enhancing software and/or image conversion software that converts images into PDF, searchable text or images that can be recognized by humans or machines. The user's scanned receipt may be enhanced and interpreted such as with the electronic receipt processing facility 128, which may include technology to remove creases, modify contrast, and the like and OCR technology to convert the scanned receipt to searchable text. Image enhancement and/or processing may be done on the user's handheld device or at an Internet location, such as a server, where the user may submit receipts. The scanned image may be automatically routed to another location for processing. Through two-way communication, the user may be advised that the image may have been successfully received for processing. In the event the user may not provide an adequate scan for processing, alternate methods of submission may be available ranging from flatbed scanners to actually mailing in the receipt.

In an embodiment, the receipt may be identified as belonging to a specific user via the telephone number from which it was submitted, the email address or home address from which it was submitted or emailed, identifying information on the receipt such as one or more of a loyalty card number, credit card number, user name, and the like.

The proof processor 110 may be able to match the text of the receipt with the known shorthand, codes, names, UPC codes, and the like for items from the terminology database 130 via an integrated matching engine. The matching engine may employ a similarity algorithm to decode product or service descriptions on receipts, using information stored in the terminology database 130, and convert them into useful data. For example, a receipt may include a number of grocery items that may be referred to using shorthand or other terminology, names or codes that may be specific to a particular grocery store. The terminology may be supplied to the terminology database 130 by the grocery store, purchased from a third party, or generated by the system 102 provider. In an embodiment, the contents of the entire receipt may be matched by the proof processor 110 or only a subset of items may be matched. For example, the receipt may have categories of products, such as certain grocery store receipts that are categorized along the lines of produce, health and beauty aids, butcher shop, and the like. In this example, the proof processor 110 may only process categories of items that align with the categories of offers selected by the user. In an embodiment, the system may take the OCR output on the entire receipt line-by-line to look for the best matches for the product or service descriptions. The terminology database may have a plurality of variations of the product or service descriptions corresponding to the various terminology used by various retailers. In an example, a similarity score threshold may be set, such as on a scale of 1 to 1000 where 1000 is a perfect match, and if one or more lines is at or above that threshold, a positive match may be declared. If more than one line is above the threshold, the system may take the highest score as the best match positive match and declare that the winner.

In an embodiment, the system 102 may include normalization technology to normalize various codes and shorthand used by different vendors for a single item. Continuing with the example of a receipt from a grocery store, bananas may be referred to as BANS by one store, and BNAS in another store, and BNNAS by a third store. The terminology database 130 may be able to normalize the various terminologies by indicating that all three terminologies refer to the same product.

In an embodiment, a predictive algorithm may be used by the system to detect unknown descriptions, build a list of terminologies used by a vendor for which the system 102 does not have database entries, and the like. Continuing with the example of grocery, a store may not choose to provide their terminologies to the terminology database 130. One way of beginning to build a terminology database 130 for the grocery store is through iterative learning from receipts.

In an embodiment, the terminologies in the terminology database 130 may be modified or corrected after receiving feedback, such as an indication from a plurality of users that a supermarket may have changed their terminology for a particular item.

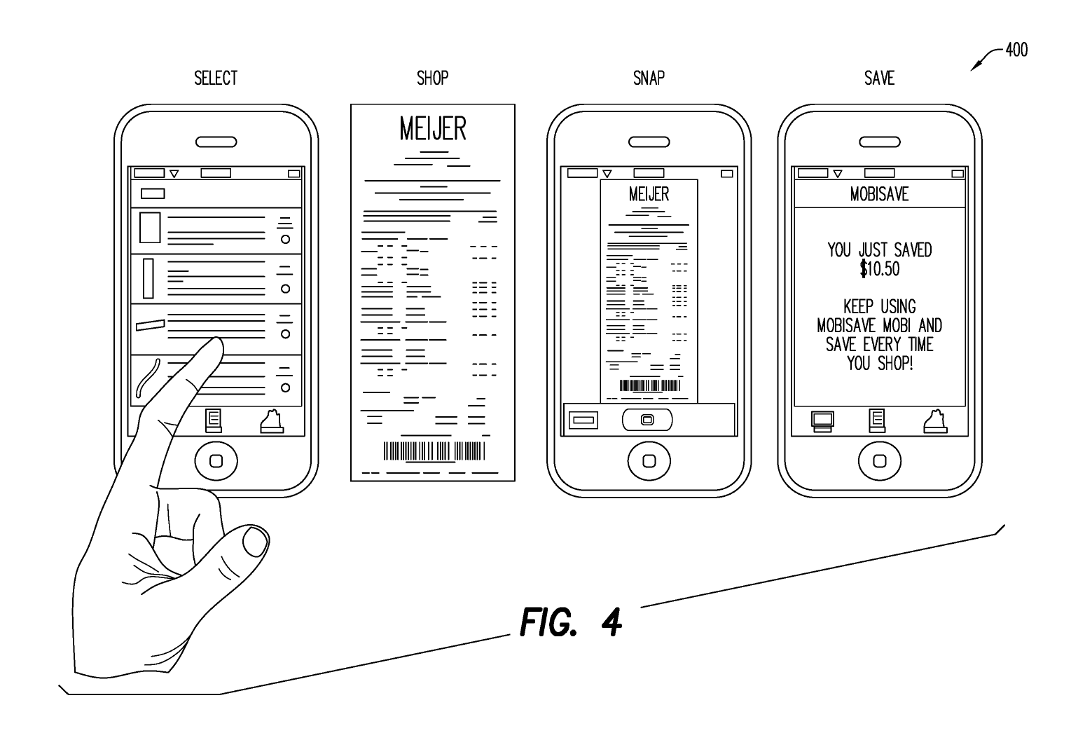

At this point, and referring to FIG. 4, a user may have interacted with the system 102 to browse and select offers that they would like to receive next time they shop. They then can go shopping and either receive a digital receipt for submission to the system or a paper receipt for imaging and image processing. In any event, the proof processor 110 may decode what products appear on the receipt using an algorithm and a terminology database 130. The proof processor 110 may then match the pre-selected offers to the products actually purchased by the user or search the products on the receipt by all known product or service descriptions for the selected offer or offers. In embodiments, a successful match may be indicated by surpassing a threshold score for similarity. For example, a positive match may be declared when one or more receipt lines score above the threshold.

When a successful match is made, an indication may be sent to a payment facility 112 that distributes the reward or rebate. In an embodiment, the user may be shown the results of the processing at the scanner location, on their handheld device or other location advising them of the promotional rewards that have been processed and approved. The reward may be a cash rebate, a mailed check, a direct deposit, rewards points, frequent flier miles, a gift card, and the like. The rewards may be credited to a holding account, sent to the user in the form of a negotiable instrument, credited to an account for later use or retrieval, sent to a bank account, optionally transmitting the payment by ACH, to a credit or debit card, to an online payment system such as PAYPAL, to a holding account that can be used for online purchases optionally with a bonus, to a stored-value card, and the like. A rewards facility 114 may communicate incentive rewards to a central location. The payment facility 112 may obtain money from an escrow account funded by a manufacturer, write to a stored-value card or perform some other financial transaction. In an embodiment, the manufacturer may pay for the redemption by directly transferring money to a user account. The user may check the status of the reward processing on their mobile phone or at any other location connected to the Internet.

In cases where there was no pre-selection of an offer, a reduced offer may be presented or a cumulative offer may be initiated. For example, the receipt scan and interpretation may show that the user purchased a bag of grapes. While there may be no current offer for grapes or the user may not have pre-selected an offer for grapes, the user may be enabled to initiate a cumulative purchase offer for future purchases of grapes. In an embodiment, the offer may be time sensitive.

When the user is informed of what they have saved, the system may then show the list of offers that were matched where the user is given the opportunity to indicate if a match was missed. If they indicate that a match was missed, the system may provide a facility for identifying the missing items, such as by highlighting the OCR'd receipt, sending an email, sending an MMS/SMS, providing feedback on a website or mobile application presenting the system, and the like. The system may then be prompted to one or more of correct the OCR, update the terminology database and credit the user for the found item.

In certain embodiments, at checkout a user may present a unique identifier recognized by the system 102, such as in the form of a card, bar code or QR code on a mobile device, RFID-embedded tag in a mobile device, NFS card, retinal scan, fingerprint, facial recognition scan, or the like. The unique identifier may be used to tag the retailer's transaction log for that user's market basket. Either on a real-time basis or any other time after purchase, the tagged transactions are used to match purchases against offers selected. Payment to users may be made as described herein.

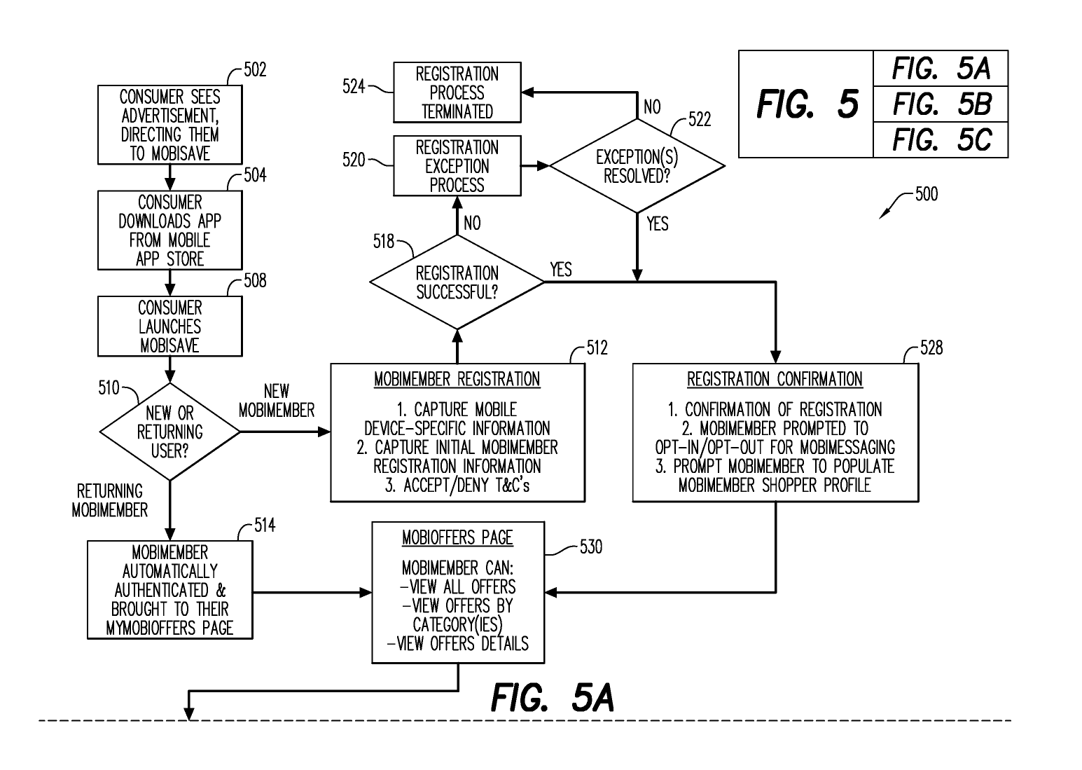

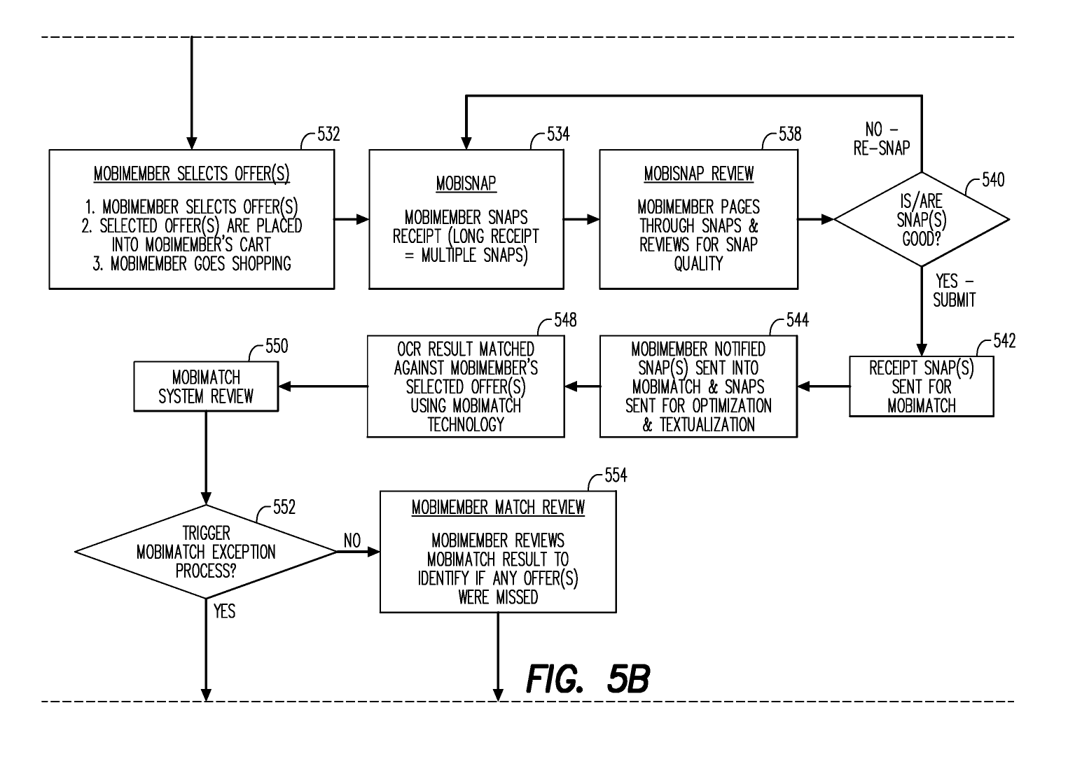

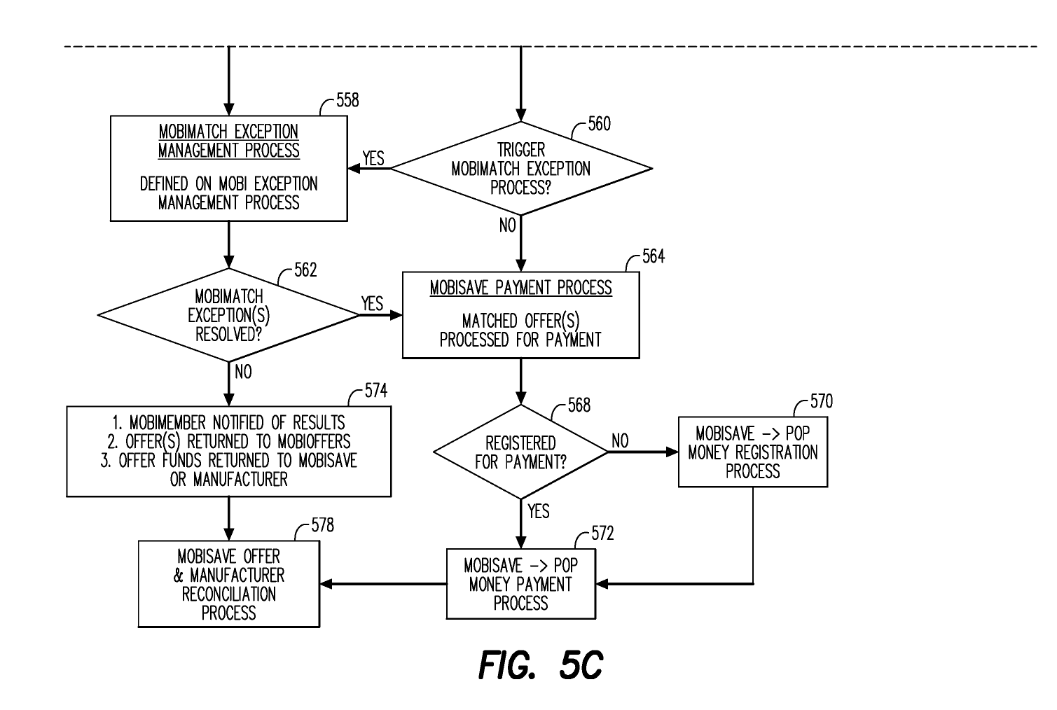

Referring to FIGS. 5A, 5B and 5C, a flowchart for an embodiment of the proof-of-performance verification system is depicted. At step 502, a user may see an advertisement directing them to a website or other portal for accessing the system 102. They may be prompted to download an application such as from an App Store at step 504 and launch the system 102 at step 508. At step 510, a test may determine if the user is new or returning. A new user may be prompted to register at step 512 where mobile device-specific and initial registration information may be captured along with acceptance or denial of terms and conditions. A test at step 518 may determine if registration was successful. If it was not, logical flow may proceed to step 520 where a registration exception process may be initiated. At step 522, a test may determine if the exception was resolved. If it was not resolved, registration may terminate at step 524. If the exception is resolved or if initial registration was successful, logical flow may proceed to registration confirmation at step 528 where users may opt-in or out of messaging and the user may populate a shopper profile. After either confirmation of a new user at step 528 or successful authentication of existing users at step 514, logical flow may continue to step 530 where users can go to a customized home page at step 530. At the customized home page, user may view offers and offer details with or without a category filter. At step 532, users may select one or more offers for placement into a system 102 cart prior to going shopping for the product(s) of the offer(s). After purchasing the one or more products, the receipt is imaged in step 534, such as via taking one or more photos of it, scanning it, faxing it, or the like. The user may review the image at step 538. A test at step 540 may determine if the image is good. If the image is good, logical processing flow may continue to step 542 on FIG. 5b. If the image is not good, logical flow returns to step 534 for re-imaging. At step 542, the receipt image, or a digital receipt, may be submitted to the system 102. At step 544, the user is notified that the imaged or digital receipt was sent into the system 102 for optimization and textualization. At step 548, the OCR result or text from the digital receipt may be matched against the user's selected offer(s) using the system's 102 matching algorithm. After a review at step 550 of the one or more matches, a test at step 552 may determine if a match exception process may be triggered. If the outcome of the test is negative, logical processing flow may proceed to step 554 where the user may review the matches to identify if any matches were missed. At step 560, another test may determine if an match exception process should be triggered. If the outcome of step 560 is negative, logical processing flow may proceed to step 564 where the matched offers may be processed for payment. If the outcome of step 560 or step 552 is affirmative, a match exception management process may be triggered at step 558. Logical processing flow then continues to a test at step 562 to determine if the match exceptions were resolved. If the outcome at step 562 is negative, logical processing flow may continue to step 574 where the user is notified of the results, the offers are returned to the system 102, and the offer funds may be returned to the system 102 or the manufacturer. Logical processing flow may then proceed to an offer and manufacturer reconciliation process at step 578. If the outcome of the test at step 562 is affirmative or the outcome of step 560 is negative, logical processing flow may continue to step 564 where the matched offers may be processed for payment. A test at step 568 may determine if the user is registered for payment. If the outcome of the test at step 568 is negative, logical processing flow may continue to step 570 where the user may register for payment either with the system or with a third party. If the outcome of the test at step 568 is positive or after registration at step 570, payment may be made at step 572. Logical processing flow may terminate at step 578 with an offer and manufacturer reconciliation process.

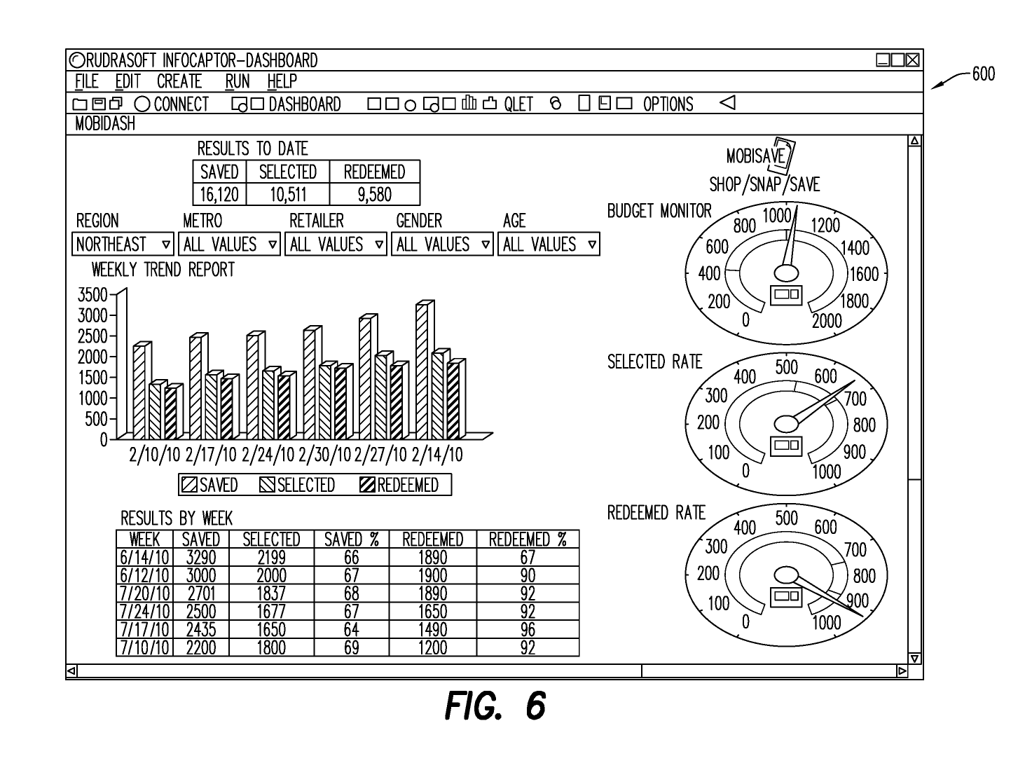

Referring now also to FIG. 6, the system may further include a reporting facility 124 that provides real-time tracking of offers and redemptions. Offer sponsors, marketers, and retailers may use a dashboard 138 to interface with the reporting facility 124 to view offer redemption tracking by any variable or measure, interface with the proof processor 110 to audit or confirm redemptions, interface with the rewards offer facility 122 to submit new offers, modify offers, delete offers, and the like, interface with a terminology database 130 to submit new terminology data for their products, modify or confirm existing data, or to delete data, interface with a user shopping database 132 to view all shopping behavior, not just behavior with respect to their products/offers, interface with a payment facility 112 to make payments, and the like. Manufacturers may use the dashboard 138 to examine data by region, metro, retailer, gender, age, product category, and the like. Manufacturers may use the dashboard 138 to examine total numbers served, offers selected, and offers redeemed. Manufacturers may use the dashboard 138 to obtain a trend report for redemptions. Manufacturers may use the dashboard 138 to examine a budget monitor, selected rate, redeemed rate and the like. Manufacturers may use the dashboard 138 to examine results by week, such as numbers served, selected, redeemed, and the like.

In an embodiment, users of the proof-of-performance verification system would not be required to search for paper coupons, clip coupons and present each coupon at checkout. Instead, this system does not require carrying individual coupons and does not require presenting them at checkout. Also, compared to traditional mail-in rebates, the user may quickly submit their proof electronically without having to fill out forms, enclose UPC codes, surrender their original receipt, pay for postage or visit the bank to cash or deposit small checks. The user may also receive notification of rewards within minutes rather than waiting weeks. The processing costs to the rewards sponsors, such as manufacturers, may be substantially reduced by automating the verification system and transmitting information and payments electronically.

Fraudulent use of digital incentives, such as home printed coupons, may be avoided because rewards are only given after verification. Also, the system may not be prone to counterfeiting, alteration or duplication of printed coupons because no self-printed material is used for actual verification. Further, the system may capture unique characteristics of each store's receipt, such as formatting, font, art, and the like, so that receipt counterfeits may be detected. Fraudulent use of newspaper coupons by retailers or individuals or organizations may be completely avoided in this system. The system may entirely circumvent retailer systems mitigating all problems associated with implementing any system that must interact with the retailers' own point-of-sale systems. This also means the system may be rapidly deployed and reward purchases made in any store including those that do not accept manufacturer coupons. In an embodiment, the system may capture information from the receipt, such as time, date, location, and transaction numbers of the receipt to detect duplicates. Having receipt information, such as the time and date, may also assure that the user has selected the offer first before purchasing or checking out. This assures offer sponsors that they are not rewarding purchases that were already made or based on found receipts. The system may track member behavior over time and examine outliers who may be perpetrating fraud. For example, the system may examine the frequency of receipt submission and the numbers of matches per receipt to identify potential fraud. The system may also sample receipts and check the originals with retailers to make sure there are no counterfeits.

In an example, a user may want to purchase a new camera from a specific manufacturer. The camera manufacturer, through the system, may offer the consumer $100 off the purchase of the camera made at any retailer via a savings certificate. Consumers, who may optionally have a membership in the system, may buy, for a fee, the $100 discount offer, such as in the form of a savings certificate, coupon, rebate, or the like. The discount offer may be purchased by the consumer on a website accessing the system or a mobile application interface to the system. Once the purchase of the specified camera may be made, a digital image of the receipt or a digital receipt may be submitted to the system using methods previously described herein, optionally along with an image, scan, swipe, tap, or manual entry of a registration card. The receipt and the optional evidence of a registration card may serve as a proof of purchase. The system would then recognize that they purchased the product associated with the offer via methods described herein and match the offer against the proof-of-purchase. In an embodiment, the discount offer may then be distributed to the user in the form of a $100 payment or credit. The payment may be sent by any means for making a payment, such as cash, check, direct deposit, credit, money order, gift card, mobile payment, and the like. The manufacturer may cover the $100 discount while the system may retain the fee. The benefit for manufacturers is they are doing rebates and providing discount offers without any processing or marketing costs and they may acquire customers because of the registration card.

In an embodiment, the offer may only be honored by the camera manufacturer if a threshold number of users purchase the specified computer.

In an embodiment, the system may enable giving and redeeming gift certificates for specific products. For example, a user may want to give a budding photographer a $100 gift certificate towards the purchase of a CANON camera. The receiver would be notified by the system that they have $100 waiting to be redeemed once they purchase the CANON camera. Once they purchase the CANON camera and provide proof-of-purchase as previously described herein, the gift certificate may be redeemed as a payment, credit, refund, or the like.

In an embodiment, a user shopping database 132 for future marketing efforts may be built from the receipt information captured. Since the entire receipt is being scanned, all of the purchase data may be stored. These sales data may be stored along with information regarding the store, the user, past purchase data, purchase behavior, redemptions history, and the like. For example, a manufacturer may be able to use purchase behavior to refine their offers, target their offers such as based on prior category purchases, eliminate offers, improve their offers, launch new products to early adopters, defend against private label, cross-sell based on lifestyle/tastes, find new product opportunities based on companion purchases, pantry load to build loyalty, reach heavy category/brand users, filter out less profitable bargain hunters, track brand switching and vulnerability, recruit search subjects quickly and inexpensively, and the like. In an embodiment, an advertisements database 134 may be included in the system 102. Manufacturers may upload advertisements to deploy to users accessing the system 102, accessing a specific offer, users requesting additional product details, and the like.

In an embodiment, a proof-of-performance verification system may include a software application either downloaded to a mobile phone, such as an IPHONE App, or other electronic processing device such as a personal home computer or laptop. The software may perform processing to facilitate verification of proof-of-performance. This processing may include receipt scanning, image enhancement, OCR conversion into searchable text, matching performance against requirements of offers, communicating with a remote processing facility that performance requirements have been met and thus having the remote processing facility provide rewards in any manner such as issuing checks, crediting accounts, making online payments, adding funds to a stored-value card or other system with writeable memory such as an RFID chip in a mobile phone, adding points or frequent flier miles to an account or any other desired manner of receiving the rewards. The system may also include using biometric finger print scanning to verify the actual user of the system as part of a registration for membership, offer selection and submission of proof.

In another embodiment, the proof-of-performance verification system 102 may not require physically imaging or scanning a receipt or other proof of performance. In this embodiment, performance data may be electronically transmitted to a mobile phone or other handheld device or directly to the rewards sponsor or the rewards sponsor processor and payment may be made directly to said handheld device which may contain a memory card such as an RFID chip. In this embodiment, actual itemized purchase data or other data held by the RFID chip in memory or other means may be transmitted to the remote location and used as proof-of-performance and said reward may be provided upon proof-of-performance by electronically communicating with the RFID chip and its payment system. For example, and without limitation, a shopper may use their mobile phone to scan product barcodes as they shop in a supermarket and then checkout by having the supermarket point of sale system scan the data collected in the mobile phone on checkout. The mobile phone may house an RFID chip which may be linked or may communicate to a bank or credit card account and the RFID chip may communicate payment information to the supermarket point-of-sale system. The itemized purchase information on that chip may also be used as proof-of-purchase for the above mentioned rewards system. The itemized purchase information would be sent from the mobile phone to the remote processing facility for verifying the purchase. The remote processing facility may then electronically communicate back to the mobile device and RFID chip which will then provide an award credit to the linked bank account or other reward repository as desired by the shopper.

The proof-of-performance verification system may be a centralized system that collects proof-of-performance data and images for later forwarding to the remote processing facility and can electronically match the offers against the proof-of-performance and capture for future use all other information contained on that receipt or other proof.

The proof-of-performance verification system may include a receipt scanner, camera, fax machine, or other device to capture an image and a display screen, such as an LCD or CRT, or mobile phone screen. The screen may have touch screen capability. The proof-of-performance verification system may include a two-way modem or other communications device hardwired or wirelessly connected to a network. The proof-of-performance verification system may include a keyboard or pin pad allowing the user to enter their identification information. The proof-of-performance verification system may include a card reader. The proof-of-performance verification system may include a reloadable stored-value card or other such card which may retain the incentive rewards for later use by the user of the system. The proof-of-performance verification system may include a facility to write to a stored-value card and or communicate incentive rewards to a central location for later use. The proof-of-performance verification system may include a payment facility to distribute the rewards.

In an embodiment, the proof-of-performance verification system may include a secure digital receipt (SDR) system to enable secure digital receipts, also referred to as paperless receipts or e-receipts, to be used for offer and rebate redemptions. For example, a shopper may have a choice of a printed paper receipt and/or having the receipt emailed or sent via SMS, MMS, and the like. In an aspect of the invention, a process for using the secure digital receipt (SDR) system may involve Traditional and Internet retailers agreeing to use the SDR system software at their checkouts. Shoppers may become a member of the SDR system and undergo a verification process to authenticate their identity, such as with personally identifiable information. At checkout, the shopper may request a secure digital receipt (SDR). The SDR may be in form of an image, such as a PDF or in text. The SDR may contain a “watermark” or some other means to prevent alteration, counterfeiting or duplication. The watermark may be in the form of a bar code, QR code, or the like containing information such as user ID, encryption device or image, encoded text, a date stamp, and the like. The SDR may also be associated with a unique sender ID, such as an email address or mobile phone number that identifies the user. The SDR system may require another form of ID such as fingerprint, eye scan, facial recognition or password to verify the identity of the user. The shopper may use the SDR in the proof-of-performance verification system as proof-of-purchase to redeem product rebates by emailing or using another digital or electronic method for submission. The SDR system may prevent shoppers from tampering, altering, duplicating or counterfeiting receipts. Such receipts may be used for rebate redemption or proof-of-purchase for returns.

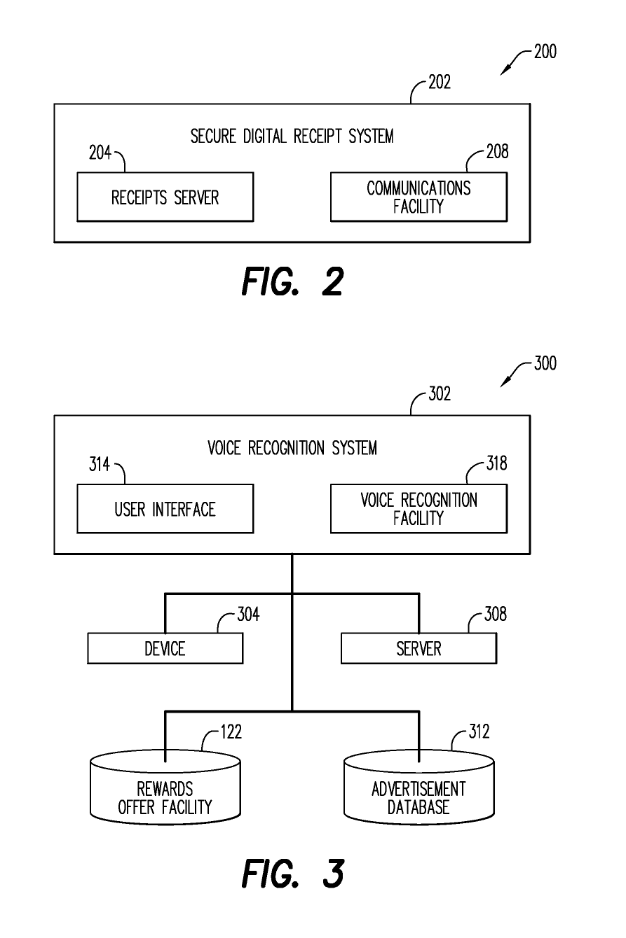

Referring to FIG. 2, a secure digital receipt system 202 may include a receipts server 204 that prepares a secure digital receipt and a communications facility 208 that delivers the secure digital receipt to a shopper.

In an embodiment, the proof-of-performance verification system 102 may include a voice recognition system 302 that may enable a user to speak into an electronic device 304, such as a computer, handheld device, mobile phone, and the like, to create a shopping list using voice recognition technology. The voice recognition system 302 may be a software application residing on the device 304 or on a server 308 including a user interface 314 and a voice recognition facility 318. The voice recognition facility 318 may recognize the spoken word as a product or brand name and create a shopping list including the recognized products and brands. In another embodiment, the shopping list may be generated from scanned bar codes. The shopping list may be printed or carried on the device into a store. In an embodiment, the shopping list may be transmitted to a shopping service that may then pick and pack the shopping list items. Using the user interface 314, the user may create a new shopping list, modify an existing shopping list, manually input new items, and the like.

In an embodiment, the proof-of-performance verification system 102 may determine if there are coupons or rebates or other purchase incentives available for the recognized items and then let the user know of their existence in any manner including, but not limited to, modifying the shopping list, sending text or email messages to the user, or any other method that communicates with the shopping list creator. For example, the proof-of-performance verification system 102 may use the voice recognition facility 318 to recognize a spoken word. Once the word is recognized, the spoken word may be searched in a database of coupons or rebates or other purchase incentives 310. If there is a match, the coupons or rebates or other purchase incentive may be communicated to the user. In an embodiment, the proof-of-performance verification system 102 may also send or display an advertising message related to the category, product or brand to the user. For example, the proof-of-performance verification system 102 may use the voice recognition facility 318 to recognize a spoken word. Once the word is recognized, the spoken word may be searched in a database of advertisements 312. If there is a match, the advertisement may be communicated to the user.

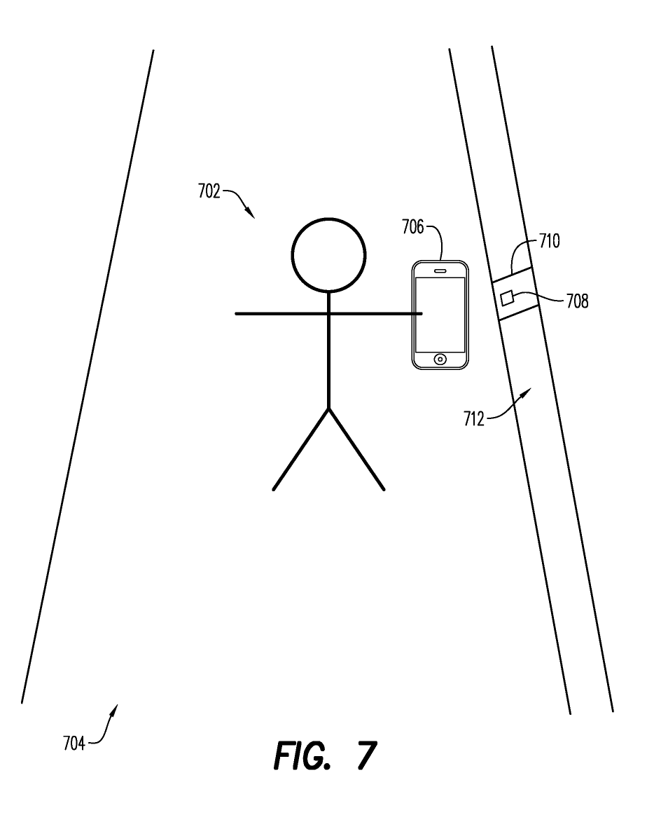

According to other aspects of this disclosure, and as schematically illustrated in FIG. 7, a competitive promotional offer system may also or alternatively be provided. As seen in FIG. 7, a shopper/user 702 is shown in a retail store aisle 704. The user 702 has with him/her a mobile device 706 that is running a suitable shopping-savings app, as discussed below. The user 702 is operating the mobile device 706 to scan a barcode 708 carried by a product item 710 located on a shelf 712 in the store aisle 704. The user 702 is scanning the barcode 708 to identify the product item 710 to a remote server (not shown in FIG. 7) to request a price comparison check on the product item—i.e., to find out whether the same product item is available elsewhere than the retail store at a lower price. As will be seen from subsequent description, and in addition to providing the price comparison to the user 702, the remote server may also generate and download to the user 702, via the mobile device 706, a targeted, tailored promotional offer for a different product item (not shown) that is competitive with the product item 710 scanned by the user 702. The competitive promotional offer may be selected by the user 702 and then redeemed by one of the proof-of-purchase techniques taught in this disclosure, as set forth above in connection with FIGS. 1-6.

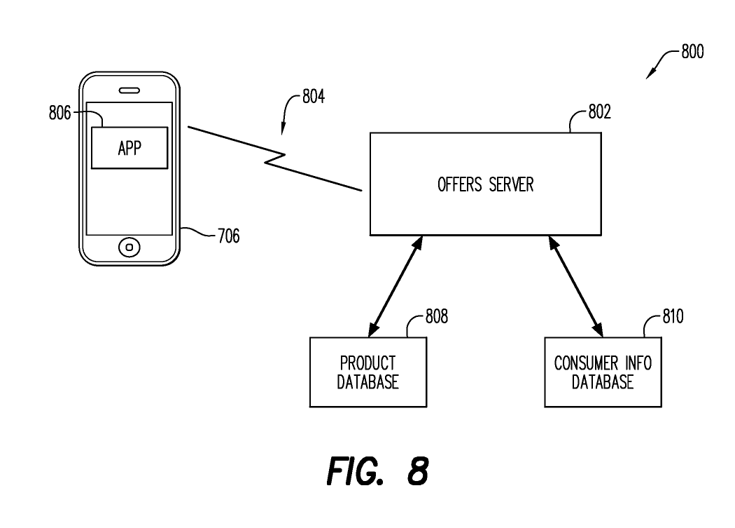

FIG. 8 depicts the above-mentioned competitive promotional offer system, generally indicated by reference numeral 800 in FIG. 8. Major functions of the competitive promotional offers system 800 may be implemented via an offers server computer 802. The offers server computer 802 may at least partially overlap with or at least share computer hardware resources with components of the above-described proof-of-performance system. Elements of the proof-of-performance system, though not explicitly shown in FIG. 8, may provide some of the functionality of the competitive promotional offers system 800. Details of the offers server computer 802 will be discussed below. Some or all of the aspects of the competitive promotional offer system 800, as described herein, may be incorporated in and/or integrated with the proof-of-performance system as described above.

Also seen in FIG. 8 is the above-mentioned mobile device 706. As indicated at 804 in FIG. 8, the mobile device 706 may be in data communication “over-the-air” with the offers server computer 802. For example the communications channel 804 may include components of a mobile communications network, which is not explicitly shown. The mobile device 706 may run a suitable shopping/saving mobile app 806, which may for example include functionality available via the “mobiSave” mobile app and/or functionality for the mobile device that forms part of embodiments of the proof-of-performance system described above. Other functionality provided by the mobile app 806 will be described below.

Continuing to refer to FIG. 8, a product database 808 may be associated with the offers server computer 802. For example, the product database 808 may be maintained in the offers server computer 802 and/or may be maintained in other computer hardware/storage hardware that is accessible by the offers server computer 802. In some embodiments, the product database 808 may contain all of the types of data included in a retail store's database of the products available for sale in the retail store, and may include substantial additional information as well. The product database may contain a large number of product entries, each corresponding to a respective product item. The product entries may include the relevant UPC code for the product item and may further include data such as product name, product size or weight, product description, model number, product category, and product characteristics such as flavor, variety, nutrition characteristics, ingredients, classifications such as “organic”, “gluten-free”, etc. The product entry may also include pricing information for the product item. The pricing information may be indicative of the current price of the product at numerous retail stores and/or online shopping outlets, and may contain links to information about the retail stores, including their locations and hours of operation. The product database 808 may be indexed to facilitate price comparisons made by the offers server computer 802 in response to in-aisle requests from the user via the mobile device 706 and the mobile app 806. In addition, the product database 808 may be indexed to support analysis by the offers server computer 802 to identify competing product items that may be the subject of competitive promotional offers generated and sent to the user by the offers server computer 802 in response to the user's price check request.

Further in regard to FIG. 8, a consumer information database 810 may be associated with the offers server computer 802. For example, the consumer information database 808 may be maintained in the offers server computer 802 and/or may be maintained in other computer hardware/storage hardware that is accessible by the offers server computer 802. In other embodiments, consumer information as required for functionality described herein may be made available to the offers server computer 802 on a service basis from a third party supplier of consumer information/demographic information, etc. In some embodiments, the consumer information database 810 may resemble many typical user databases. It may include an entry for each user. Each entry may be keyed to an identifier, such as the unique identifier for the copy of the mobile app 806 that is running on the user's mobile device 806. The consumer information database 810 may, for example, include data indicative of the user's past purchase data, purchase behavior, redemptions history, and so forth, as collected from the user's past interactions with the proof-of-performance system (e.g., as in the user shopping database 132 described above) and/or as collected from the user's past interactions with the offers server computer 802. In addition, the consumer information database 810 may include one or more of a shopping history, a shopper profile, a demographic profile and/or a socio-economic profile for the user. The shopping history may include, but may not be limited to, the information in the user shopping database 132 concerning the user.

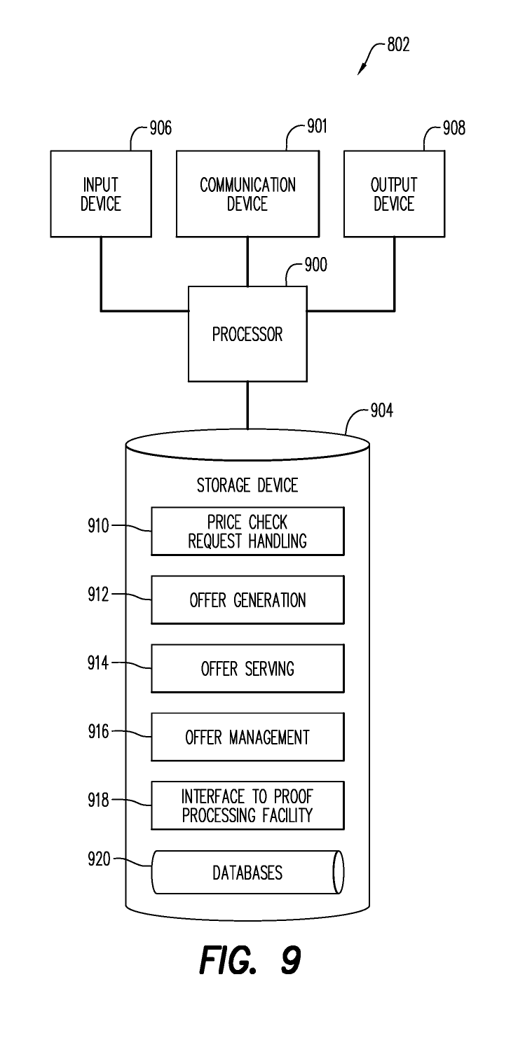

FIG. 9 is a block diagram that depicts an example embodiment of the offers server computer 802.

Referring now to FIG. 9, the offers server computer 802 may, in its hardware aspects, be constituted with typical mainframe computer and/or server computer hardware. Other example hardware embodiments are described below.

The offers server computer 802 may include a computer processor 900 operatively coupled to a communication device 901, a storage device 904, an input device 906 and an output device 908. The processor 900 may be in communication with the communication device 901, the storage device 904, the input device 906 and the output device 908.

The computer processor 900 may be constituted by one or more single or multi-core processors. Processor 900 operates to execute processor-executable steps, contained in program instructions described below, so as to control the offers server computer 802 to provide desired functionality.

Communication device 901 may be used to facilitate communication with, for example, other devices (such as numerous mobile devices 706; and/or components of the proof-of-performance system). For example, communication device 901 may comprise numerous communication ports (not separately shown), to allow the offers server computer 802 to communicate simultaneously with a number of other computers and other devices—including mobile devices, including communications as required to simultaneously handle numerous price check requests and to push numerous competitive promotional offers to numerous users.

Input device 906 may comprise one or more of any type of peripheral device typically used to input data into a computer. For example, the input device 906 may include a keyboard and a mouse. Output device 908 may comprise, for example, a display and/or a printer.

Storage device 904 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 904 may store software programs for controlling processor 900. The programs comprise program instructions (which may be referred to as computer readable program code means) that contain processor-executable process steps of the offers server computer 802, executed by the processor 900 to cause the offers server computer 802 to function as described herein.

The programs may include one or more conventional operating systems (not shown) that control the processor 900 so as to manage and coordinate activities and sharing of resources in the offers server computer 802, and to serve as a host for application programs that run on the offers server computer 802.

For example, the storage device 804 may store an application program 910 that may program the processor 900 to enable the offers server computer 802 to handle price comparison requests from users of the competitive promotional offers system 800.

In addition, the storage device 804 may store a further application program 912 that may program the processor 900 to enable the offers server computer 802 to generate competitive promotional offers as described herein. As discussed below, the offers generation program 912 may be triggered by price comparison requests handled by the program 910.

Further, the storage device 804 may store an application program 914 that may program the processor 900 to enable the offers server computer 802 to transmit/serve the offers generated by the program 912 to the pertinent user mobile devices.

Moreover, the storage device 904 may store a program 916 to manage offers that the program 912 has generated. This may include keeping track of the offers, receiving the users' acceptance/selection thereof, and communicating with, e.g., the proof processing facility 110 (FIG. 1) such that selected competitive promotional offers (i.e., such offers selected by users) are added to the current list of offers selected by and available for redemption by the users in question.

Still further, the storage device 904 may store a software interface 918 to program the processor 900 to facilitate interaction between the offers server computer 802 and the proof processing facility 110.

The storage device 904 may also store, and the offers server computer 802 may also execute, other programs, which are not shown. For example, such programs may include a reporting application, which may respond to requests from system administrators for reports on the activities performed by the offers server computer 802. The other programs may also include, e.g., one or more data communication programs, database management programs, device drivers, etc.

The storage device 904 may also store one or more databases 920 as required for operation of the offers server computer 802. The databases 920 may, for example, include either or both of the product database 808 and the consumer information database 810.

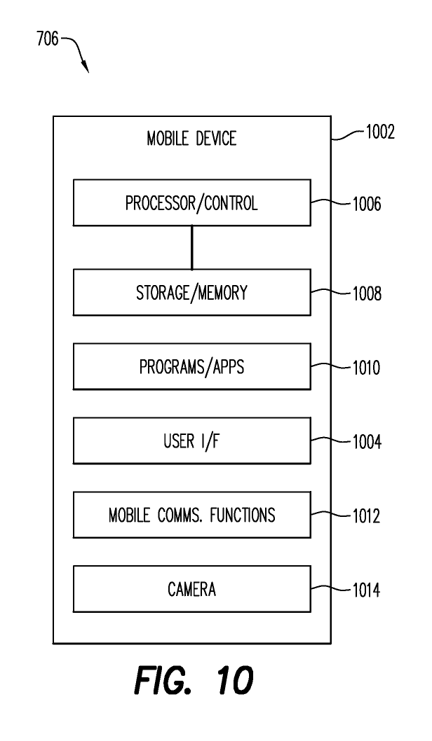

FIG. 10 is a block diagram that depicts a typical one of the mobile devices 706, particularly on the assumption that, in a particular case, the mobile device 706 is constituted by a smartphone that is running one or more suitable mobile apps.

In one embodiment, the mobile device 706 may have a typical configuration and characteristics of a smartphone in its hardware aspects and also in many of its software aspects, except that the mobile device 706 may be programmed suitably to allow it to request price comparisons and to receive competitive promotional offers, as described herein. In many, or perhaps all respects, the user device 708 may implement functionality—in regard to capture and forwarding of purchase transaction receipts—as described above in connection with the mobile device depicted in FIG. 4 and referred to in the above-description of the proof-of-performance system.

The mobile device 706 may include a housing 1002. In many embodiments, the front of the housing is predominantly constituted by a touchscreen (not separately shown), which is a key element of the user interface 1004 of the mobile device 706.

The mobile device 706 further includes a mobile processor/control circuit 1006, which is contained within the housing 1002. Also included in the mobile device 706 is a storage/memory device or devices (reference numeral 1008). The storage/memory devices 1008 are in communication with the processor/control circuit 1006 and may contain program instructions to control the processor/control circuit to manage and perform various functions of the mobile device 706. As is well-known, such functions include operation as a mobile voice communication device via interaction with a mobile telephone network (not shown). Further conventional functions include operation as a mobile data communication device, and also as what is in effect a pocket-sized personal computer, via programming with a number of application programs, or “apps”. (The apps are represented at block 1010 in FIG. 10, and may in practice be stored in block 1008, to program the processor/control circuit 1006 in myriad ways.) The above-referenced mobile communications functions are represented by block 1012, and in addition to programmed control functions, the mobile communications functions also rely on hardware features (not separately shown) such as an antenna, a transceiver circuit, a microphone, a loudspeaker, etc.

In addition, as is commonly the case with smartphones, the mobile device 706 may include a camera 1014, which may provide digital images for storage in and/or processing by the mobile device 706. As will be appreciated in view of the above-descriptions of capturing images of paper purchase transaction receipts, the camera 1014 may be operated for that purpose in connection with proof of performance relative to competitive promotional offers implemented in the competitive promotional offers system 800.

From the foregoing discussion, it will be appreciated that the blocks depicted in FIG. 10 as components of the mobile device 706 may in effect overlap with each other, and/or there may be functional connections among the blocks which are not explicitly shown in the drawing.

It has been posited that the mobile device 706 may be embodied as a smartphone, but this assumption is not intended to be limiting, as the mobile device 706 may alternatively, in at least some cases, be constituted by a tablet computer that has mobile communication capabilities or by other types of mobile computing devices.

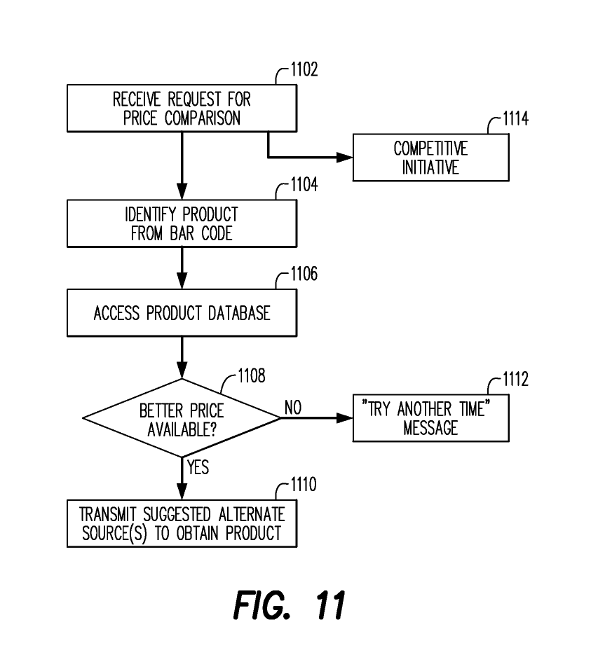

FIG. 11 depicts a process that may be performed in the competitive promotional offers system 800.

At 1102 in FIG. 11, the offers server computer 802 may receive a request for a price comparison from the user 702 schematically illustrated in FIG. 7. It will be appreciated that the request may be transmitted to the offers server computer 802 via the mobile device 706 using the above-mentioned app 806. For example, the user may have selected a price comparison option from the app 806 and may then capture an image of the barcode 708 for the product item 710 for which the user desires to check the price. The request as received at the offers server computer 802 may include an image of the barcode or a translation of the barcode into numeric UPC data. (The latter may occur if the capabilities of the app 806 include reading product barcodes.) Geolocation information may also be included in the price comparison request as received by the offers server computer 802. The geolocation information may indicate the retail store location from which the user is sending the price comparison request. The price comparison request may also identify the user, e.g., by including the identification information for the unique copy of the shopping app downloaded to the user's mobile device.

If the barcode has not been translated, then block 1104 (FIG. 11) may be performed by the offers server computer 802. At 1104, the offers server computer 802 may identify the product scanned by the user from the barcode included in the price comparison request.

At 1106, the offers server computer 802 may access the product database 808 to obtain information relevant to the price comparison request. The information obtained may include the price of the product item at the user's current store location identified in the price comparison request. The information obtained may also include the current price of the product item at other stores within a pre-determined distance from the user's current store location. Where appropriate, given the type of the product item, the information obtained may also include the price of the item at online shopping outlets.

Decision block 1108 may follow block 1106. At decision block 1108, the offers server computer 802 may determine, based on the price information obtained at 1106, whether there is a better price available for the product item either at a nearby store other than the user's current store location, or available online. If the offers server computer 802 makes a positive determination at decision block 1108 (i.e., if the offers server computer 802 has found a better price for the product item at a source that is reasonably convenient for the user), then block 1110 may follow block 1108. At block 1110, the offers server computer 802 may transmit a response to the price comparison request to indicate the finding(s) that a better price is available from one or more other sources apart from the retail store from which the user transmitted the price comparison request. The response may be transmitted from the offers server computer 802 to the user's mobile device 706 via the communications channel 804 (FIG. 8) and may be received and displayed through operation of the app 806. The response may indicate the lower prices that were found by the offers server computer 802 and the geolocation(s)/web address(es) of the alternative source(s).

Referring again to decision block 1108 in FIG. 11, if a negative determination is made at that decision block (i.e., if no better price is found), then block 1112 may follow decision block 1108. At block 1112, the offers server computer 802 may send a response that indicates no better price is found, and that the user is encouraged to try again with another price comparison request on a different product item.

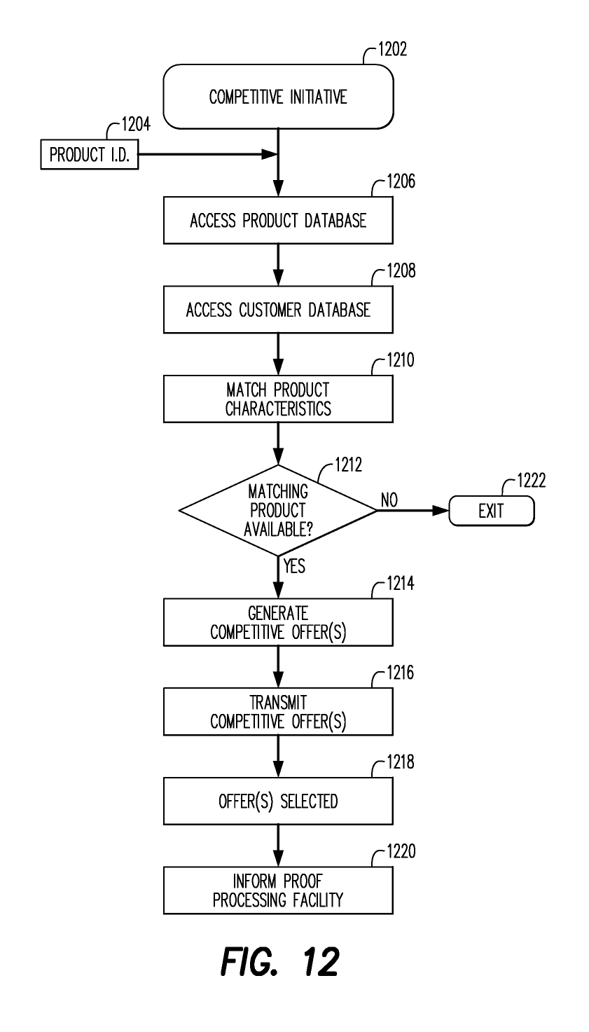

Continuing to refer to FIG. 11, and as indicated at block 1114, receipt by the offers server computer 802 of the price comparison request may also trigger the offers server computer 802 to undertake a “competitive initiative”—that is, an effort to generate one or more competitive promotional offers relative to the product item for which the price comparison request was made. Details of the competitive initiative are illustrated in flow chart form in FIG. 12, starting with block 1202 to indicate commencement of the competitive initiative process.

As indicated at 1204, the identification of the product item that was the subject of the price comparison request may be imported to the competitive initiative process from the price comparison process. The identity of the user may also be made available to the competitive initiative process.

At 1206, the offers server computer 802 may access the product database 808 to gather information to identify one or more other product items that may be the subject of a competitive promotional offer. In some embodiments, the product items may be screened such that only product items also available at the retail store where the user is currently shopping will be considered for being the subject of a competitive promotional offer. In addition, or alternatively, the potential competitive product items may be screened such that only products offered by manufacturers with a promotion agreement with the operator of the competitive promotional offers system 800 will be considered for being the subject of a competitive promotional offer. In some embodiments, the offers server computer 802 may gather information as required from the product database 808 to identify product items with at least one product characteristic in common with the product item that was the subject of the price comparison request. In some embodiments, the offers server computer 802 may gather information as required from the product database 808 to identify product items that are similar to and/or substantially interchangeable with the product item that was the subject of the price comparison request. In some embodiments, the offers server computer 802 may gather information as required from the product database 808 to identify product items that overlap to a substantial extent in terms of product characteristics with the product item that is the subject of the price comparison request.

At 1208, the offers server computer 802 may access consumer information database 810 to gather information about the user that may be relevant to determining whether to propose a competitive promotional offer in this situation, and if so, according to what terms and/or with what level of benefit/incentive. The information gathered from the consumer information database 810 may, for example, be relevant to determining the user's potential value as a customer for the manufacturer of a potential competitive product item. In some embodiments, the information gathered about the user from the consumer information database 810 may be such as is required by one or more rules prescribed by the manufacturer of the potential competitive product. In some embodiments, first the potential competitive product may be identified, then the manufacturer of the potential competitive product may be identified, and then rules regarding the necessary user information required by the manufacturer may be determined, and thereafter the required information may be gathered by the offers server computer 802 from the consumer information database 810.

Block 1210 represents analysis by the offers server computer 802 to determine whether the information gathered from the product database 808 indicates that there is a potential matching/competitive product item that would be a suitable subject for a competitive promotion offer.

Decision block 1212 may follow block 1210 in the process of FIG. 12. At decision block 1212, the offers server computer 802 may determine whether a suitable competitive product item has been identified relative to the product item that was the subject of the price comparison request. If so, the process may advance from decision block 1212 to block 1214. At block 1214, the offers server computer 802 may generate at least one competitive promotional offer to be presented to the user 702. Then, at block 1216, the offers server computer 802 may transmit the competitive promotional offer (e.g., via the communications channel 804) to the user 702 via the user's mobile device 706.

For purposes of the example process illustrated in FIG. 12, it is assumed that the user accepts/selects the competitive promotional offer that was transmitted from the offers server computer 802 and received by the mobile device 706. The user's selection of the competitive promotional offer may be accomplished via an interaction between the user 702 and the app 806. Details of an example interaction of this kind will be provided below. An indication that the user 702 has selected the competitive promotional offer may be transmitted from the mobile device 706 to the offers server computer 802 (e.g., via the communications channel 804). Block 1218 in FIG. 12 represents the offers server computer 802 receiving the indication that the user 702 has selected the competitive promotional offer.

Block 1220 may follow block 1218. At block 1220, the offers server computer 802 may communicate with the proof processor 110 (FIG. 1) in such a manner that the proof processor 110 adds the selected competitive promotional offer to the list of offers that have been selected by the user and thus are available for redemption by the user according to one of the redemption processes described above in the description of the proof of performance system. For example, the user may place the competitive product item in his/her shopping cart. The user may then check out with his/her items for purchase and may obtain a paper purchase transaction receipt printed at the checkout counter. The receipt may show that the competitive item was among the items purchased by the user. The user may then utilize the mobile device 706 to “snap” (i.e. capture/obtain an image of) the paper purchase transaction receipt. The mobile device 706 may then submit the paper receipt image to the proof processor 110. The proof processor may parse the paper receipt image in a manner described above to identify the competitive product item as having been purchased by the user at a point in time later than the point in time at which the user selected the competitive promotional offer. The proof processor matches the line item from the paper receipt image to the selected competitive promotional offer, thereby leading the user to be provided with a benefit (e.g., a rebate amount) in accordance with the terms of the selected competitive promotional offer. From previous description, it will be appreciated that the user may, for example, receive a credit of a monetary amount to an account owned by the user.

Referring again to decision block 1212 in FIG. 12, if at that decision block a negative determination is made, then the process may branch from decision block 1212 to 1222 (i.e., exit from the process of FIG. 12).

A specific narrative example will now be provided to further illustrate the processes described above with reference to FIGS. 11 and 12.

In this example, a customer/shopper (e.g., the user 702) is present at a merchant location—i.e., a retail store, which may be a grocery store or another type of store. The user 702 has a mobile device (reference numeral 706) with a mobile shopping app (reference numeral 806) running on the mobile device. The user wishes to purchase Brand B strawberry yogurt. However, before putting that item in his/her shopping basket, the user wishes to quickly get a price comparison to see if the price marked on the yogurt container is a good price.

The user interacts with the app 806 on the mobile device 706. The app prompts the shopper to scan a barcode (e.g., a UPC code or other product identification code). Alternatively, the user may type in information to identify the product item. The user directs the mobile device and its camera to capture the barcode from the yogurt container (or from a tag on the store shelf). The user may also enter the retail price of the yogurt at the store where the user is currently shopping.

The app 806 sends a message to the offers server computer 802 requesting price comparison information associated with the product item (i.e., the yogurt), sending the UPC for the product item. The app 806 may also send geolocation data (obtained from the mobile device) as well as information identifying the user.

The offers server computer 802 uses the UPC or other product item identifier to look up attributes of the product. The offers server computer 802 determines that the product is “yogurt, fat free, strawberry”, size: 6 Oz.; Brand: B, Manufacturer: XYZ Co., Serving size: 1 container, servings per container: 1. The offers server computer 802 may also determine nutrition facts, ingredients and other attributes of the product.

According to one process flow, the offers server computer 802 may go forward with a recommendation as to where the user can get the same product item at a better price. That is, the offers server computer 802 may use the geolocation information (or information about the user's shopping preferences) to perform a price comparison to determine whether any retailers near the user's current location have better prices on the product item. For example, the offers server computer 802 may retrieve prices from merchants the user typically frequents in the user's neighborhood, or merchants within a predetermined distance from the user's current location or the user's home location. This retrieval of prices may include access to the product database 808. If better prices are identified at other retailers (within the constraints referred to above), information about the prices and the merchants is returned to the app 806 from the offers server computer 802 for display to the user. The offers server computer 802 may also take into consideration the store hours of operation and the current time in determining whether to suggest purchasing the product item at another store.

According to another process flow, a competitive promotional offer (i.e., relating to an alternative product to purchase instead of the Brand B yogurt) may be identified and presented.

In this process flow, the offers server computer 802 uses product information, customer information and geolocation information (or a combination thereof) to identify an alternative/competitive product item. The competitive product item may be identified based on characteristics of the Brand B product item. The identification process may be such that the identified competitive product item is substantially equivalent to the Brand B product item. For example, the competitive product item in this particular example may be generally equivalent in terms of (i) pricing, (ii) product size, (iii) nutritional data, and/or (iv) ingredients, etc. In this example involving yogurt, the competitive product may be Brand B low fat strawberry greek yogurt, assuming—for example—that the competitive product is in a similar price range, with similar nutritional content and ingredients.

The offers server computer 802 identifies one or more competitive products, and then may proceed with further processing. The further processing may include determining whether there are manufacturer or retailer discounts or offers available to encourage the user to purchase the competitive product instead of the Brand B product. The offers server computer 802 may make this determination by interacting with an offers database and/or by applying offer rules established with the offers server computer 802 by one or more manufacturers of competitive products.

If a competitive product is identified, and an offer is available or can (under applicable rules) be generated for the competitive product, then the offers server computer 802 returns to the app 806 information about the competitive product and the offer, for display to the customer.

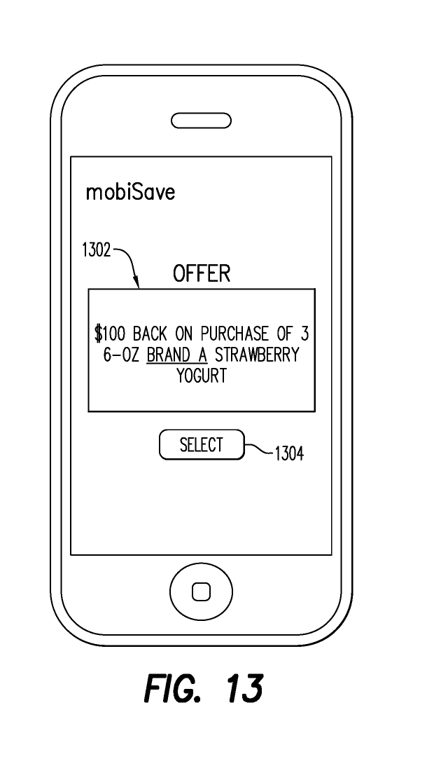

Referring now to FIG. 13, a competitive promotional offer 1302—of this type—is shown displayed on the mobile device 706. A select button 1304 is available for the user to touch, to indicate that the user has selected the offer. If the user does so, the indication that the user has selected the competitive promotional offer may be transmitted from the mobile device 706 to the offers server computer 802, and received by the offers server computer 802, as referred to above in connection with FIG. 12. In other embodiments, the competitive offer may be deemed “pre-selected” upon transmission to the user, and is immediately available for redemption without requiring any other response to the offer from the user.

The user may redeem the selected offer by purchase of the competitive product, with proof of performance and payment to the user as per, for example, the proof of performance system described above.

For example, the user, who initially intended to purchase the Brand B yogurt, may be encouraged to purchase the Brand A yogurt; that purchase may be incentivized by a suitable rebate/benefit to the user, deposited in the user's account upon confirmation of the purchase. The incentive may be funded by the manufacturer, the retailer, or a combination of entities.

The amount of the incentive may be dynamically determined based on one or more characteristics of the user, such as shopping history, potential lifetime value of the user as a customer for the competitor, and so forth. From earlier discussion, it will be appreciated that the offers server computer 802 may include or have access to a database of consumer characteristic information (e.g., the consumer information database 810), including a database entry or entries for the user.

The incentive, in some embodiments and/or in some situations, may be something other than a cash or discount incentive. For example, an incentive may be a complementary or related product offer. In the yogurt example, the user may be offered 50% off the purchase of granola if the customer purchases the Brand A yogurt instead of the Brand B yogurt. Purchases of both the granola and the Brand A yogurt may be confirmed based on processes described above with reference to the proof of performance system.

In some embodiments, the user may interact with the app 806 to request a competitive promotional offer from the offers server computer 802 without requesting the price comparison. In some embodiments, the user may view a shopping list on the mobile device provided via the app 806, and may be periodically queried/prompted as to whether the user wishes to request a competitive promotional offer. The user may respond to the prompt by scanning a product code to launch the request for the promotional competitive offer.

With intervening competitive promotional offers, provided at the time the user is making his/her purchasing decision, the competitive promotional offer system 800 may provide an exceptionally effective and efficient marketing channel for product manufacturers. The offers provided by the system may be very timely, targeted and tailored to the user's tastes, interests and value as a customer, and thus may represent a more efficient expenditure of promotional budgets than less time- and user-specific offers. The offer provided by the system may result in influencing or changing the user's purchasing behavior right at the point of selection of the item to be purchased, so that the sponsor of the offer may intercept a purchase from a competitor and change the purchase to the sponsor's product.

In other embodiments, promotional offers may be generated in a context that is also keyed to real-time user behavior. For example, a user may order a drink at a bar. For example, the user may order a certain brand (Brand C) of beer, ale, wine or whiskey. When the bartender serves the ordered drink, he/she may also provide a beverage coaster to the user. The beverage coaster may include a QR code or other automatically readable code and an offer for a rebate/discount on a subsequent retail store purchase of the same brand of beverage in a bottle or can or a package including bottles or cans of the beverage. The user may employ his/her mobile device to capture the code, which may be transmitted by the app in the mobile device to a remote offers server. The server may then transmit the offer to the mobile device for display to the user via the user interface. The user may then indicate selection of the offer; an indication of the selection of the offer may be transmitted from the mobile device to the offers server. Thereafter, the user may redeem the selected offer by making the purchase of the bottled/canned beverage/beverage package at a retail store, and then using the mobile device to capture an image of the paper transaction receipt that indicates the purchase. The mobile device may then transmit the captured image to a remote server for redemption of the selected offer in accordance with embodiments of the proof of performance system as described above.

In some embodiments described above, proof-of-performance is demonstrated to qualify for rewards or offers by submitting images of paper transaction receipts that are verified and matched to offers by a verification system. According to an alternative approach to proof-of-performance, products eligible for offers may carry RFID (radio frequency identification) tags or the like to permit the products to “identify themselves” by wireless communication. When a user brings a qualifying product home, the product tag may identify the product by wireless communication to a WiFi system in the user's home. The user may have previously registered their home WiFi system with the offer verification system. The user's WiFi system may transmit a message to the offer verification system to indicate that the user bought the product and brought it home. The RFIC chip may be active or passive; in at least the latter case, the RFID chip may be interrogated by the user's home WiFi system.

In a variation on the above product-tagging proof-of-performance approach, the user's mobile device may be involved. At a set-up stage, the user may register for the proof-of-performance system and download a suitable app to his his/her mobile device. The user may input—to the app—data that identifies the user's home WiFi system. When the user brings an eligible and tagged product home, the RFID tag on the product may be interrogated by the user's WiFi system to obtain product identification information (e.g., a UPC). The WiFi system may then communicate with the user's mobile device to indicate that the product has been purchased and brought home by the user. The mobile device may forward this proof-of-performance information via the internet to the offer verification system, with the information including the product identification code, the WiFi system identifier and the user's home location. The corresponding rebate may be transferred to the user via Paypal or by another funds transfer mechanism, including mechanisms described above.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The processes and/or flow charts in this disclosure should not be considered to prescribe a particular order for performing the process steps shown or discussed. Rather, the process steps may be performed in any order that is feasible, including simultaneous performance of at least some steps.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method comprising:
receiving an indication that a user is requesting a price comparison with respect to a product available for sale in a retail store aisle, the indication received at a time when the user is present in the aisle;
determining a competitive item that shares a product characteristic with the product available for sale in the aisle; and
transmitting an offer to the user to induce the user to purchase the competitive item.

2. The method of claim 1, wherein the transmitting step occurs while the user is in the store aisle.

3. The method of claim 2, wherein the transmitted offer includes an incentive that reduces an effective price of the competitive item.

4. The method of claim 3, further comprising:
looking up shopper data, the shopper data including at least one of: (a) a shopping history for the user; (b) a shopper profile for the user; (c) a demographic profile for the user; and (d) a socio-economic profile for the user; and
determining an amount of the incentive based at least in part on the looked-up shopper data.

5. The method of claim 1, further comprising:
receiving an indication that the user has selected the transmitted offer.

6. The method of claim 5, further comprising:
receiving an image of a paper transaction receipt, the image representing purchased item data;
parsing the received image to extract the purchased item data;
detecting that at least a portion of the extracted purchased item data matches the selected offer; and
in response to a result of the detecting step, providing a benefit to the user in accordance with the selected offer.

7. The method of claim 5, further comprising:
receiving an electronic transaction receipt, the electronic transaction receipt representing purchase item data;
parsing the received electronic transaction receipt to identify the purchased item data;
detecting that at least a portion of the identified purchased item data matches the selected offer; and
in response to a result of the detecting step, providing a benefit to the user in accordance with the selected offer.

8. The method of claim 5, wherein said indication that the user is requesting a price comparison and said indication that the user has selected the transmitted offer are received from a mobile application running on a mobile device operated in the aisle by the user.

9. A mobile device, comprising:
a processor;
program memory in communication with the processor, the program memory storing program instructions; and
a housing containing the processor and program memory;
the housing shaped and sized to be held in one hand by a user;
the processor operative with the program memory to perform functions as follows:
transmitting to a remote server an indication that the user is requesting a price comparison with respect to a product available for sale in a retail store aisle, the indication transmitted at a time when the user is present in the aisle with the mobile device; and
receiving, from the remote server, an offer to the user to induce the user to purchase a competitive item, the competitive item sharing a product characteristic with the product for which price comparison was requested.

10. The method of claim 9, wherein the offer is received at a time when the user is in the store aisle with the mobile device.

11. The method of claim 10, wherein the received offer includes an incentive that reduces an effective price of the competitive item.

12. The method of claim 11, wherein the processor is further operative with the program instructions to display the received offer to the user via a user interface of the mobile device.

13. The method of claim 12, wherein the processor is further operative with the program instructions to transmit, to the remote server, an indication that the user has selected the received offer.

14. The method of claim 13, wherein the processor is further operative with the program instructions to:
capture an image of a paper transaction receipt, the paper transaction receipt indicating purchase of the competitive item after the transmission of the indication that the user has selected the received offer; and
transmit the captured image to the remote server.

15. A method comprising:
storing a product database, the product database including a plurality of product data entries, each product data entry including a product name and at least one product characteristic;
receiving a competition initiative query, the competition initiative query specifying a first product, said first product of competitive interest, said first product distributed by a first manufacturer;
searching the product database to identify a second product, said second product distributed by a second manufacturer in competition with the first manufacturer; the second product sharing at least one characteristic with the first product; and
responding to the competition initiative query by identifying the second product.

16. The method of claim 15, wherein:
the first and second products are food items, the first and second products sharing at least one of (a) a product type; (b) a flavor; and (c) a size.

17. The method of claim 15, wherein each of the product data entries includes retail price information for a respective product listed in said each product data entry.

18. The method of claim 17, wherein said retail price information includes a plurality of prices, each of said prices corresponding to a respective retail store location at which the respective product is for sale.

19. A mobile device, comprising:
a processor;
program memory in communication with the processor, the program memory storing program instructions; and
a housing containing the processor and program memory;
the housing shaped and sized to be held in one hand by a user;
the processor operative with the program memory to perform functions as follows:
capturing an image of a bar code that appears on a beverage coaster;
transmitting the captured image to a remote server;
receiving, from the remote server, an offer with respect to a bottled or canned alcoholic beverage identified by the bar code;
displaying the received offer to a user via a user interface of the mobile device;
transmitting, to the remote server, an indication that the user has selected the received offer;
capturing an image of a paper transaction receipt, the paper transaction receipt indicating purchase of at least one bottle or can of said alcoholic beverage; and
transmitting the captured image of the transaction receipt to the remote server.

20. The method of claim 19, wherein the indicated purchase is a purchase of a package of bottled or canned beer or ale.
